(19) United States
(12) Patent Application Publication
(10) Pub. No.: US 2025/0041033 A1
(43) Pub. Date: Feb. 6, 2025

(54) CUSTOMIZED PADS AND RELATED METHODS FOR DENTAL APPLIANCES

(71) Applicant: Stuart Levy, Mason, OH (US)

(72) Inventor: Stuart Levy, Mason, OH (US)

(21) Appl. No.: 18/921,272

(22) Filed: Oct. 21, 2024

Related U.S. Application Data
(63) Continuation of application No. PCT/US2023/025253, filed on Jun. 14, 2023.
(60) Provisional application No. 63/354,949, filed on Jun. 23, 2022.

(51) Int. Cl. A61C 13/225; A61C 9/00; A61C 13/34; B23K 26/38; B33Y 10/00; B33Y 50/02; B33Y 80/00

(52) U.S. Cl. CPC A61C 13/225; A61C 9/0006; A61C 13/34; B23K 26/38; B33Y 10/00; B33Y 50/02; B33Y 80/00

(57) ABSTRACT

A method of manufacturing a pad to secure a dental appliance to a gum of a patient including creating a digital model of a gum facing portion of the dental appliance and using the digital model to manufacture the pad. Manufacturing the pad includes creating a profile defining a perimeter of the pad from the digital model and cutting the pad from a sheet of material using the profile. Manufacturing the pad includes 3D printing the pad. Creating the digital model includes 3D scanning the gum facing portion of the dental appliance. Creating the digital model includes 3D scanning an impression of the gum facing portion of the dental appliance.

### CROSS REFERENCE TO RELATED APPLICATION

This application is a continuation of PCT Application Serial No. PCT/US2023/025253, filed on Jun. 14, 2023 (pending), which claims priority to U.S. Provisional Patent Application Ser. No. 63/354,949, filed Jun. 23, 2022 (expired), the disclosures of which are incorporated herein by reference in their entirety.

### TECHNICAL FIELD

The present disclosure generally relates to adhesive pads for dental appliances, and specifically adhesive pads for dental prosthetics, and related methods.

### BACKGROUND

It is estimated that there are 23 million people in the US who are fully edentulous, another 12 million who are edentulous in one arch, and 90% of those people wear dentures. Although overall edentulism has decreased, it remains a significant issue with approximately 17% of adults over the age of 65 being edentulous. With so many people wearing dentures, the market for dental adhesives in the US is estimated to be over 2 billion dollars and predicted to grow. Worldwide edentulism and the use of dental adhesives is significantly larger.

Many dentures are fabricated with substandard results that can be due to poor techniques, poor lab results, poor patient compliance, poor case selection, lack of saliva, etc. resulting in poor denture fit. While it is recommended by the ADA that dentures should be replaced every 5 years due to changes in the bone and tissue as well as wear and tear, most denture wearers are not seen by a dentist after they receive their dentures unless they are having a problem. Most people wear the same set of dentures for 5, 10, 15 years or more.

Dentures may not stay in place and/or may move around due to poor fit, forces from the tongue, and lack of saliva. Solutions include dental implants which are expensive and only a small percentage of patients can afford the treatment, new dentures, in-office or lab relines of the dentures, and use of over the counter dental adhesives.

Current dental adhesives consist of pastes, creams, powders, and pre-fabricated generically sized dental adhesive pads. Current dental adhesives may work to a certain extent, but with messy, sticky materials that do not always hold and/or fill the voids between the denture and the tissue.

Accordingly, and despite the various advances already made in this field, there is a need for further improvements related to devices, systems, and methods related to adhesive pads for dental appliances.

### SUMMARY

Generally, a method of manufacturing a pad to secure a dental appliance to a gum of a patient is provided. The method includes creating a digital model of a gum facing portion of the dental appliance and using the digital model to manufacture the pad. In some embodiments, the method may include 3D scanning the gum facing portion of the dental appliance to create the digital model. In alternate embodiments, the method may include 3D scanning an impression of the gum facing portion of the dental appliance to create the digital model. The dental appliance may be a denture or other dental prosthetic, for example.

In some embodiments, the method of manufacturing the pad includes creating a profile defining a perimeter of the pad from the digital model and cutting the pad from a sheet of material using the profile. The method of manufacturing the pad may include using a laser to cut the pad from the sheet of material.

In some embodiments, the method of manufacturing the pad includes applying an adhesive to the sheet of material before cutting the pad from the sheet of material. In alternate embodiments, the method of manufacturing the pad includes applying an adhesive to the pad after cutting the pad from the sheet of material. In some embodiments, the method of manufacturing the pad includes storing the digital model electronically. In some embodiments, the method of manufacturing the pad includes 3D printing the pad.

Generally, a pad to secure a dental appliance to a gum of a patient is provided. The pad is produced using a method including creating a digital model of a gum facing portion of the dental appliance and using the digital model to manufacture the pad. The pad includes a pad shaped to cover at least a portion of a gum facing portion of the dental appliance. In some embodiments, the pad includes an adhesive coupled to the pad and configured to secure the pad to the dental appliance. In some embodiments, the pad includes an adhesive coupled to the pad and configured to secure the dental appliance to the gum of the patient. In some embodiments, the adhesive covers at least a portion of the pad. In some embodiments, the adhesive is embedded in at least a portion of the pad. In some embodiments, the pad is configured to fill voids at least partially between the gum facing portion of the dental appliance and the gum of the patient.

Generally, a kit for making an impression of a gum facing portion of a dental appliance is provided. The kit includes a putty for making the impression of the gum facing portion of the dental appliance and a container for shipping the impression. The putty can be pressed against the gum facing portion of the dental appliance to make the impression, the putty hardens and/or cures, the impression can be removed from the dental appliance after the putty has hardened and/or cured, and the impression can be sealed in the container and shipped. In some embodiments, the putty includes at least two parts, combining the parts causes the putty to harden and/or cure, and the putty is pliable for an interval of time after the parts are combined.

Generally, a method of making and shipping an impression of a gum facing portion of a dental appliance is provided. The method of making and shipping an impression includes pressing a putty against the gum facing portion of the dental appliance to make the impression, allowing the putty to harden and/or cure, removing the impression from the dental appliance after the putty has hardened and/or cured, placing the impression in a container, and shipping the impression. In some embodiments, the method of making and shipping an impression may include procuring a kit for making the impression of the gum facing portion of the dental appliance, the kit including the putty for making the impression of the dental appliance, and the container for shipping the impression. In some embodiments, the putty includes at least two parts and the method includes combining the two parts of the putty.

Additional aspects and advantages of the invention will become more apparent upon further review of the detailed description of the illustrative embodiments taken in conjunction with the accompanying drawings.

### BRIEF DESCRIPTION OF THE DRAWINGS

FIG. 1 is a perspective view of an illustrative denture pad and denture.

FIG. 2 is a perspective view of the illustrative denture pad and denture of FIG. 1 showing the denture pad installed on the denture.

FIG. 3 is a perspective view of the illustrative denture of FIG. 1 being 3D scanned.

FIG. 4 is a perspective view of an illustrative two-part putty in an illustrative package.

FIG. 5A is a perspective view of the illustrative putty and package of FIG. 4 showing the package being opened.

FIG. 5B is a perspective view of the two parts of the putty of FIG. 4 being combined for use.

FIG. 6 is a perspective view of an illustrative impression being made of a gum facing portion of the denture of FIG. 1.

FIG. 7 is a perspective view of the illustrative impression and denture of FIG. 6 showing the impression being removed from the denture and being placed in a shipping container.

FIG. 8 is a perspective view of the impression of FIG. 6 showing the gum facing portion of the impression being 3D scanned.

FIG. 9 is a perspective view of denture pads being cut from a sheet of material.

### DETAILED DESCRIPTION

Generally, a denture pad to secure a dental appliance to the gums of a patient and methods for manufacturing the denture pad are disclosed herein. For illustrative purposes and as used herein, the term patient refers to a person who wears dentures and the term caregiver refers to a person who provides care and/or assistance to a person who wears dentures. While the present detailed description is directed to a denture pad and the dental appliance is a denture, the invention in its broader aspects may be implemented for making pads to secure other dental appliances.

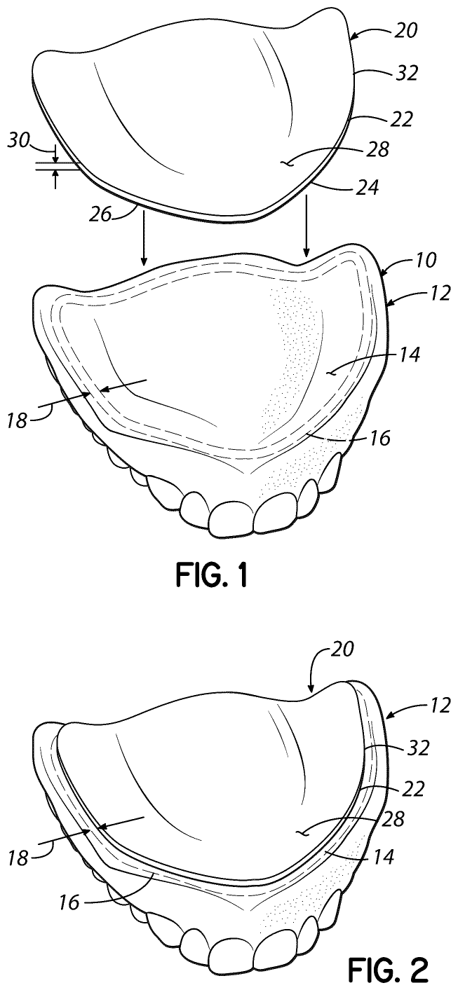

FIG. 1 is a perspective view of an illustrative dental appliance and denture pad and FIG. 2 is a perspective view showing the denture pad installed on the dental appliance. In this illustrative embodiment, the dental appliance 10 is a denture 12. The denture 12 includes a gum facing portion 14 and an edge 16 defining an outline and/or perimeter of the gum facing portion 14. The term “gum facing portion” does not mean to imply that the dental appliance 10 must contact or engage with the gums of a patient but instead is a term that is meant to differentiate the portion of the dental appliance 10 that generally faces the natural gums of a patient from one or more other portions of the dental appliance 10 that do not face the natural gums of the patient. While the denture 12 is illustrated as an upper denture, it will be appreciated that the devices and methods described herein are applicable to both upper and lower dentures, as well as other dental appliances. The term “denture” refers to any denture appliance, such as upper dentures, lower dentures, partial dentures, immediate dentures or any other denture appliance.

The illustrative denture pad 20 includes a pad 22 and an adhesive 24. In this illustrative embodiment, the adhesive 24 covers at least a portion of a denture facing surface 26 of the pad 22. In some embodiments, the adhesive 24 covers or is applied to at least a portion of a gum facing surface 28 of the pad 22. In alternate embodiments, the adhesive 24 is embedded within the pad 22.

Referring to FIGS. 1 and 2, the pad 22 is shaped to cover a portion of the gum facing portion 14 of the denture 12 to secure the denture 12 against the gums of a patient while the denture 12 is being worn by the patient. The pad 22 is flexible allowing the pad 22 to conform to the gum facing portion 14 of the denture 12. The pad 22 is sized to be a distance 18 inside of the edge 16 that allows for the fit of the denture pad 20 to the denture 12 and/or to the patient's gums to be tailored to the patient's needs. The distance 18 may be within a range of 0 mm to 15 mm, for example. In this illustrative example, the pad 22 is sized to be a distance 18 of 5 mm inside of the edge 16. The distance 18 may vary around a perimeter 32 or outer edge of the denture pad 20. In this illustrative example, the denture pad 20 is replaced daily. A patient or caregiver installs the denture pad 20 on the denture 12 before placing the denture 12 against the patient's gums. The patient or caregiver removes the denture pad 20 from the denture 12 when the denture 12 is removed from the patient's mouth. In some embodiments, the denture pad 20 allows the denture 12 to be positioned and repositioned on the patient's gums without the need to replace the denture pad 20.

The pad 22 has a thickness 30, and the thickness 30 of the pad 22 may vary depending on the fit requirements of the patient and/or the denture 12. The pad 22 has a stiffness, and the stiffness of the pad 22 may vary depending on the fit requirements of the patient and/or the denture 12. In some embodiments, the denture pad 20 and/or pad 22 is constructed of a plurality of layers, the sum of the thicknesses of the layers equaling the thickness 30 of the pad 22. The layers may have varying thicknesses and/or stiffnesses. Some patients may achieve an acceptable denture fit with a stiffer or less pliable pad 22 with a relatively small thickness 30, for example. Other patients may require a softer or more pliable pad 22 with relatively large thickness 30 to compensate for contour differences between the gum facing portion 14 of the denture 12 and the patient's gums to achieve an acceptable fit of the denture 12, for example. In some embodiments, the thickness 30 is not uniform throughout the pad 22. The plurality of combinations of stiffness and/or thickness 30 of the pad 22 allow for the fit of the denture pad 20 to the denture 12 and/or to the patient's gums to be tailored to the patient's needs. The denture pad 20 is custom fit to the denture 12 as described herein. A patient who wears both upper and lower dentures would use a unique denture pad 20 for each of the upper and lower denture 12.

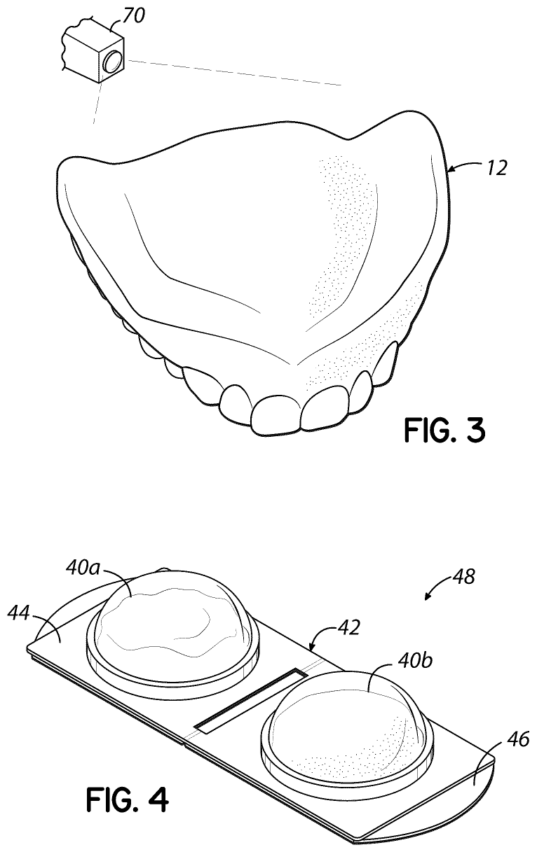

FIG. 3 is a perspective view of the illustrative denture 12 being 3D scanned. An illustrative method of manufacturing a denture pad 20 includes creating a digital model of the gum facing portion 14 of the denture 12 and using the digital model to produce the denture pad 20. In this illustrative method, creating the digital model includes 3D scanning the gum facing portion 14 of the denture 12. 3D scanning includes using a 3D scanner 70, or similar device, to 3D scan and/or measure the gum facing portion 14 of the denture 12. 3D scanners may be in dental offices, dental labs, hospitals, drugstores, and/or kiosks at drugstores, for example. In other instances, a portable 3D scanner may be transported to the rehabilitation facility, nursing home, hospital, etc., where the patient is being treated or cared for, for example. In some cases, a patient or caregiver, for example, would take the denture 12 to a dental office, dental lab, hospital, or drugstore to have the gum facing portion 14 of the denture 12 3D scanned. In some cases, a nurse, pharmacist, or pharmacy tech, for example, would 3D scan the gum facing portion 14 of the denture 12. In some cases, a dental technician or dentist, for example, would 3D scan the gum facing portion 14 of the denture 12. In other cases, a patient or caregiver, for example, would take the denture 12 to a kiosk to 3D scan the gum facing portion 14 of the denture 12. Due to the speed and accuracy of 3D scanners, a patient, for example, would only need to wait a short period of time for the 3D scan to be completed before receiving the denture 12 back from being 3D scanned. The 3D scan of the gum facing portion 14 is used to create a digital model of the gum facing portion 14. In some methods, the digital model may be a 3D model. In some methods, the digital model may be a 2D model. The digital model is stored electronically for later use, along with an identification number and information associated with the patient, for example.

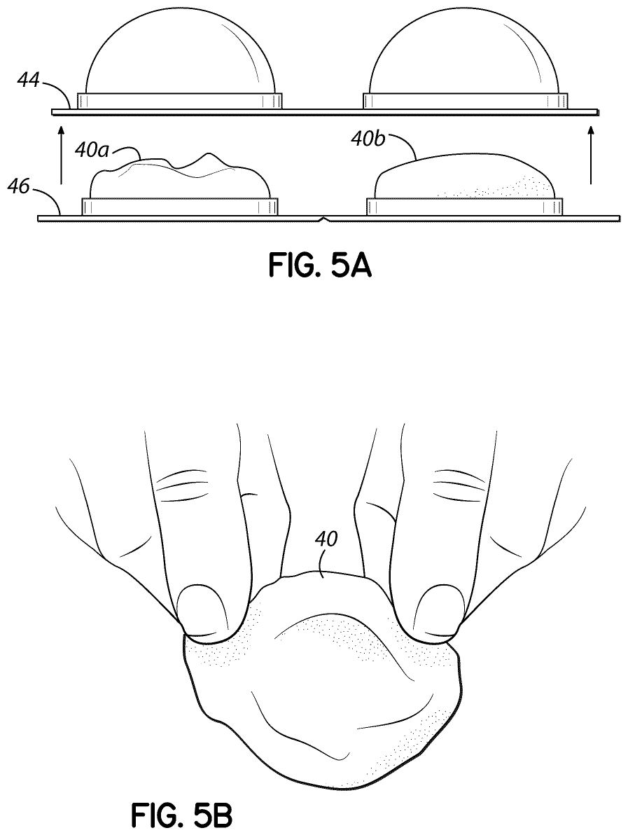

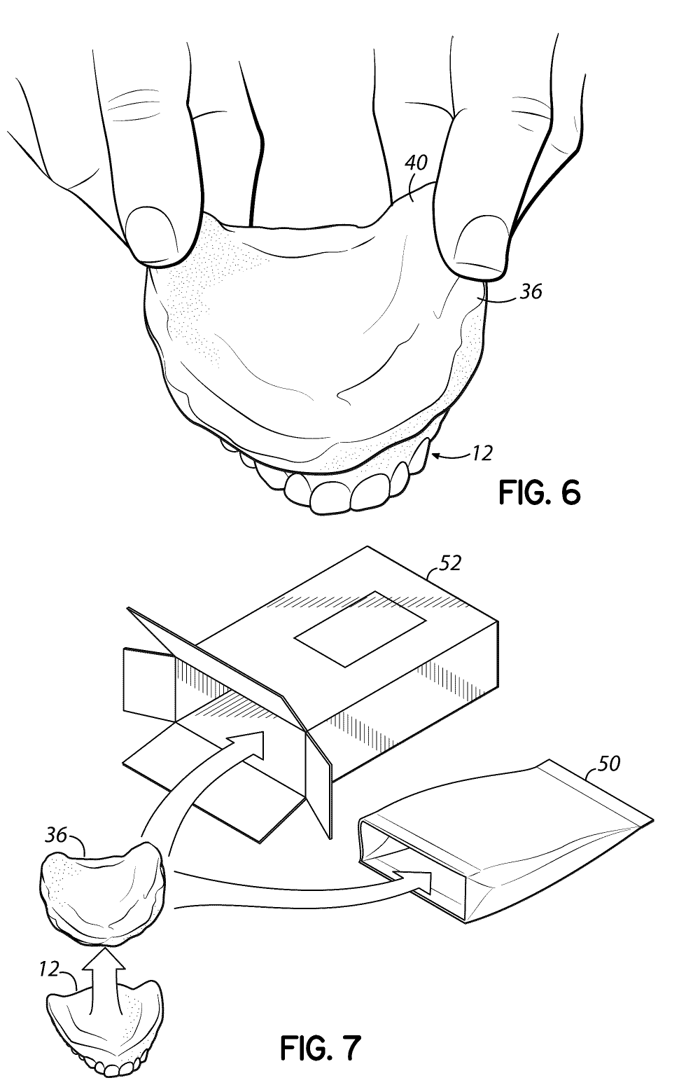

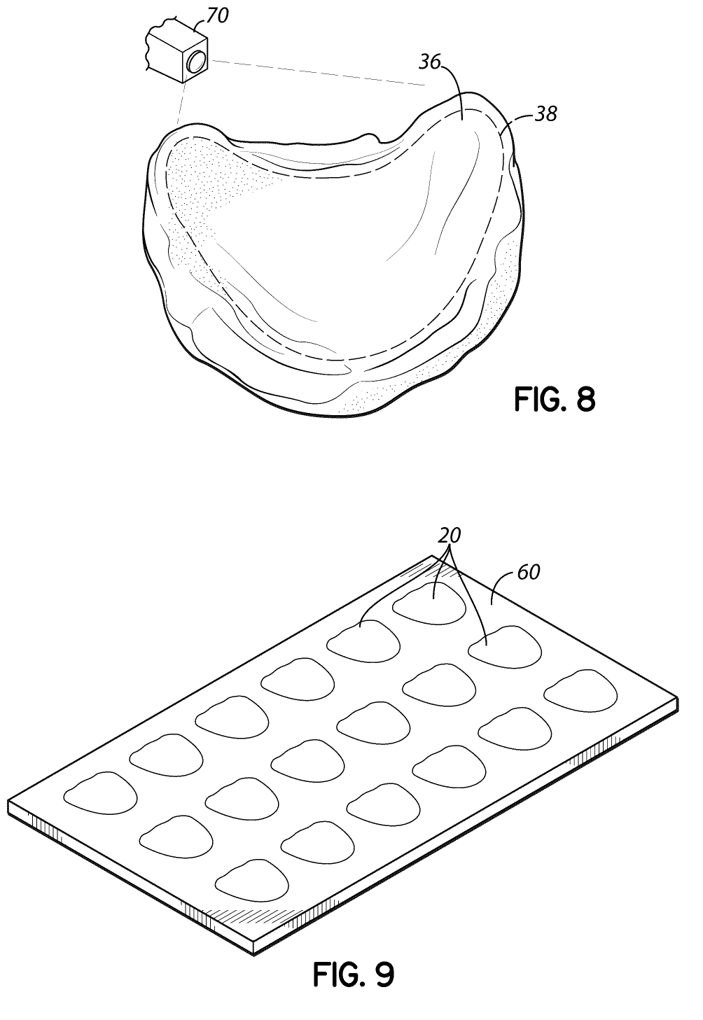

FIG. 4 is a perspective view of an illustrative two-part putty 40 in an illustrative package 42, FIG. 5A is a perspective view showing the package 42 being opened, and FIG. 5B is a perspective view of the two parts 40a, 40b of the putty 40 being combined for use. FIG. 6 is a perspective view of an illustrative impression 36 being made of the gum facing portion 14 of the denture 12. FIG. 7 is a perspective view of the impression 36 being removed from the denture 12 and being placed in a shipping container. FIG. 8 is a perspective view of the impression 36 showing the impression being 3D scanned.

An illustrative method of manufacturing a denture pad 20 includes creating an impression 36 of the gum facing portion 14 of the denture 12 and scanning a portion of the impression 36 to create a digital model of the gum facing portion 14 of the denture 12 to produce the denture pad 20.

Referring to FIGS. 4, 5A, and 5B, in some embodiments, the method of creating an impression 36 includes combining at least two parts 40a, 40b of the putty 40. In this illustrative example, the two parts 40a, 40b of the putty 40 are provided in a package or container 42 with a base 46 and a lid 44 as part of an impression kit 48. In some embodiments, combining the two parts 40a, 40b of the putty 40 includes removing the lid 44 from the base 46 of the container 42, as shown if FIG. 5A, removing the two parts 40a, 40b from the container 42, and mixing the two parts 40a, 40b to make the putty 40. Mixing the two parts 40a, 40b may include kneading the two parts 40a, 40b, as shown in FIG. 5B, until the putty 40 is a uniform consistency. In some embodiments, the two parts 40a, 40b may be different colors and mixing the two parts 40a, 40b may include mixing and/or kneading until the putty 40 is a uniform color.

Referring to FIGS. 6-8, an illustrative method of creating an impression 36 of the gum facing portion 14 of the denture 12 includes pressing the putty 40 against the gum facing portion 14 (see FIG. 6), allowing the putty 40 to harden and/or cure to make the impression 36, and removing the impression 36 from the denture 12 (see FIG. 7). In this illustrative embodiment, the putty 40 remains flexible after the putty 40 cures allowing for easy removal of the impression 36 from the denture 12. In some instances, making the impression 36 may include pressing the denture 12 into the putty 40. Making an impression 36 of a lower denture 12, for example, may include forming the putty 40 into a cylindrical shape, like a cigar, and pressing the putty 40 against the gum facing portion 14 of the denture 12. In some cases, a patient, caregiver, nurse, pharmacist, or pharmacy tech, for example, would make the impression 36. In some cases, a dental technician or dentist, for example, would make the impression 36. A patient, for example, would only need to wait a short period of time for the putty 40 to harden and/or cure before removing the impression 36 from the denture 12, thereby minimizing the time a patient would not have the use of the denture 12. It should be appreciated by one of ordinary skill in the art that the cure time of the putty 40 may vary and may be tailored to allow for longer or shorter cure times to aid in the creation of the impression 36. In some embodiments, the putty 40 may be polyvinyl siloxane, silicone, or similar material that is suitable to obtain an accurate and stable impression 36. The impression 36 needs to remain accurate and stable over an extended period of time which could include incidental events such as delays in shipping, temperature changes, etc.

The impression 36 is delivered to a 3D scanner location for 3D scanning of the impression 36. 3D scanners may be in manufacturing facilities, dental offices, dental labs, hospitals, and/or kiosks at drugstores, for example. Delivery of the impression 36 to a 3D scanner location may include placing the impression 36 in a mailing pouch 50 or box 52 (see FIG. 7) and sending the impression 36 through the US mail, for example. In some cases, a patient or caregiver, for example, takes the impression 36 to a dental office, or dental lab to have the impression 36 3D scanned. In other cases, a patient or caregiver, for example, takes the impression 36 to a kiosk to 3D scan the impression 36. 3D scanning includes using a 3D scanner, or similar device, to 3D scan and/or measure a portion of the impression 36. A portion of the impression 36 which is an impression of the gum facing portion 14 of the denture 12 is shown by dashed line 38. The 3D scan of the impression 36 is used to create a digital model of the gum facing portion 14 of the denture 12. In some methods, the digital model may be a 3D model. In some methods, the digital model may be a 2D model. The digital model is stored electronically for later use, along with an identification number and information associated with the patient, for example.

Referring to FIG. 9, in this illustrative embodiment, the denture pad 20 or pad 22 is cut from a sheet 60. In this illustrative embodiment, the sheet 60 includes the material to make the pad 22 and the adhesive 24. Cutting the denture pad 20 and/or pad 22 from the sheet 60 may involve die cutting, laser cutting, and/or other methods for cutting a shape from the sheet 60. In some embodiments, the digital model is used to create a profile defining the perimeter 32 or outer edge of the denture pad 20 and/or pad 22. In some embodiments, the profile is used to program a cutting machine, such as a laser, for example, to cut the denture pad 20 and/or pad 22 from the sheet 60. In some embodiments, the profile is used to make tooling, such as a die for use in a cutting machine, for example, to cut the denture pad 20 and/or pad 22 from the sheet 60.

In some embodiments, the sheet 60 includes the adhesive 24 and cutting the denture pad 20 from the sheet 60 produces the denture pad 20. In some embodiments, the adhesive 24 is applied to the sheet 60 before the denture pad 20 is cut from the sheet 60. In some embodiments, the adhesive 24 is applied to the pad 22 after the pad 22 is cut from the sheet 60 to produce the denture pad 20. In some embodiments, the sheet 60 includes a plurality of layers. In some embodiments, the denture pad 20 and/or pad 22 is cut from a plurality of sheets 60 and the plurality of cut layers are combined to produce the denture pad 20.

In alternate embodiments, the denture pad 20 and/or pad 22 may be constructed using 3D printing or similar additive manufacturing process, for example. The digital model is used to program the 3D printer and/or additive manufacturing machine or machines. In some embodiments, the denture pad 20 and/or pad 22 may be constructed of multiple layers of material of varying stiffness and/or thickness, for example. In some embodiments, the adhesive 24 is applied to the denture pad 20 and/or pad 22 as part of the 3D printing process. In some embodiments, the adhesive 24 is applied to the pad 22 after the pad 22 is 3D printed to produce the denture pad 20. In some embodiments, the adhesive 24 is a component of the materials used to 3D print the denture pad 20 and/or pad 22. In some embodiments, the denture pad 20 and/or pad 22 is 3D printed as a flat component. In alternate embodiments, the denture pad 20 and/or pad 22 is 3D printed with a contour matching the gum facing portion 14 of the denture 12.

The digital model is stored electronically, and additional adhesive denture pads 20 can be manufactured using the stored digital model. A patient, caregiver, dentist, lab, or technician can order adhesive denture pads 20 as needed and the adhesive pads 20 can be delivered to the patient or caregiver, for example. Adhesive pads 20 can easily be ordered through a website, an app on a mobile device, and/or by making a phone call, for example. Alternatively, a patient or caregiver can receive adhesive denture pads 20 as part of a subscription service, receiving a periodic 30-, 60-, or 90-day supply, for example. Some methods of providing the denture pad 20 to a patient or caregiver include providing an impression kit 48 (see FIG. 4) including the putty 40 and a shipping container such as a mailing pouch 50 or a box 52 (see FIG. 7) to a patient or caregiver, for example. Impression kits 48 and/or adhesive denture pads 20 may be sold directly to dental offices, for example. Dental offices may provide impression kits 48 and/or adhesive denture pads 20 directly to patients or caregivers, for example. Dental offices with the appropriate equipment may produce impression kits 48 and/or adhesive denture pads 20, for example. The impression kit 48 can be sold to patients, caregivers, and other consumers through retailers such as pharmacies, department stores, and on-line retailers, for example. The impression kit 48 could also be sold or provided directly to patients, caregivers, and other consumers by the manufacturer of the denture pad 20.

In alternate embodiments, adhesive denture pads 20 may be produced in conjunction with permanent dentures and/or temporary dentures. Temporary dentures are also referred to as immediate dentures. Temporary dentures may be placed in the patient's mouth on the same day that a dentist extracts teeth. Temporary dentures protect the patient's gum tissue as the patient's mouth heals from the tooth extraction. Temporary dentures are worn for several months after tooth extraction while awaiting the arrival of permanent dentures. Temporary dentures are not custom fit to a patient's gums like permanent dentures, so temporary dentures often will not fit well. The denture pad 20 may improve the fit and comfort of temporary dentures.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A method of manufacturing a pad to secure a dental appliance to a gum of a patient, the method comprising:
creating a digital model of a gum facing portion of the dental appliance; and
using the digital model to manufacture the pad.

2. The method of claim 1 wherein creating the digital model comprises 3D scanning the gum facing portion of the dental appliance.

3. The method of claim 1 wherein creating the digital model comprises 3D scanning an impression of the gum facing portion of the dental appliance.

4. The method of claim 1 wherein manufacturing the pad comprises:
creating a profile defining a perimeter of the pad from the digital model; and
cutting the pad from a sheet of material using the profile.

5. The method of claim 4 comprising using a laser to cut the pad from the sheet of material.

6. The method of claim 4 further comprising applying an adhesive to the sheet of material before cutting the pad from the sheet of material.

7. The method of claim 4 further comprising applying an adhesive to the pad after cutting the pad from the sheet of material.

8. The method of claim 1 further comprising storing the digital model electronically.

9. The method of claim 1 wherein manufacturing the pad comprises 3D printing the pad.

10. A pad to secure a dental appliance to a gum of a patient, the pad produced using the method of claim 1 and comprising a pad shaped to cover at least a portion of a gum facing portion of the dental appliance.

11. The pad of claim 10 further comprising an adhesive coupled to the pad and configured to secure the pad to the dental appliance.

12. The pad of claim 11 wherein the adhesive is configured to secure the dental appliance to the gum of the patient.

13. The pad of claim 11 wherein the adhesive covers at least a portion of the pad.

14. The pad of claim 11 wherein the adhesive is embedded in at least a portion of the pad.

15. The pad of claim 10 wherein the pad is configured to fill voids at least partially between the gum facing portion of the dental appliance and the gum of the patient.

16. A kit for making an impression of a gum facing portion of a dental appliance, the kit comprising:
a putty for making the impression of the gum facing portion of the dental appliance; and
a container for shipping the impression;
wherein the putty can be pressed against the gum facing portion of the dental appliance to make the impression, the putty hardens and/or cures, the impression can be removed from the dental appliance after the putty has hardened and/or cured, and the impression can be sealed in the container and shipped.

17. The kit of claim 16 wherein the putty comprises at least two parts, combining the parts causes the putty to harden and/or cure, and the putty is pliable for an interval of time after the parts are combined.

18. A method of making and shipping an impression of a gum facing portion of a dental appliance, the method comprising:
pressing a putty against the gum facing portion of the dental appliance to make the impression;
allowing the putty to harden and/or cure;
removing the impression from the dental appliance after the putty has hardened and/or cured;
placing the impression in a container; and
shipping the impression.

19. The method of claim 18 further comprising procuring a kit for making the impression of the gum facing portion of the dental appliance, the kit including:
the putty for making the impression of the dental appliance, and
the container for shipping the impression.

20. The method of claim 18 wherein the putty includes at least two parts and the method further comprises combining the two parts of the putty.
